(19) United States
(12) Patent Application Publication
(10) Pub. No.: US 2026/0048739 A1
(43) Pub. Date: Feb. 19, 2026

(54) BRAKE TEMPERATURE BASED SPEED-CONTROLLING

(71) Applicant: Tesla, Inc., Austin, TX (US)

(72) Inventors: Anand Swaminathan, Sunnyvale, CA (US); Justin Sill, Cupertino, CA (US); Christopher Satkoski, San Jose, CA (US)

(21) Appl. No.: 19/102,263

(22) PCT Filed: Aug. 29, 2023
(86) PCT No.: PCT/US2023/031420

§ 371 Date: Feb. 7, 2025

Related U.S. Application Data
(60) Provisional application No. 63/374,218, filed on Aug. 31, 2022.

(51) Int. Cl. B60W 30/14; B60T 8/172; B60T 17/22

(52) U.S. Cl. CPC B60W 30/146; B60T 8/172; B60T 17/221; B60W 2510/18; B60W 2720/10

(57) ABSTRACT

A speed-controlling process limits the speed of a vehicle to make sure brakes can slow down the vehicle without overheating. The speed-controlling process includes estimating a current temperature of at least one brake. The speed-controlling process then calculates a speed limit of the vehicle, for example at which the brake would not exceed a maximum temperature when applied to slow down the vehicle to a stop. The speed-controlling process can limit the vehicle at or below the speed limit by setting a motor torque limit.

### CROSS-REFERENCE TO RELATED APPLICATIONS

This application claims priority to U.S. Provisional Ser. No. 63/374,218, filed Aug. 31, 2022, the entire disclosure of which is incorporated by reference in its entirety and for all purposes.

### TECHNICAL FIELD

The present application relates to a process of controlling the speed of a vehicle. More particularly, the process of controlling speed can be based on an estimation of the brake capability of the vehicle.

### BACKGROUND

A vehicle brake slows down a vehicle by friction between the brake pads and a rotor of the vehicle. While braking, kinetic energy is converted into thermal energy, Therefore, heat can build up and overheat the brakes when a vehicle is braked heavily, repetitively, and/or for a long period of time. Overheated vehicle brakes can result in brake fades due to loss or reduced friction between the brake pads and the rotor. Brakes can also experience irreversible damage if allowed to reach certain temperatures. Therefore, brake fade or permanent brake damage can happen when the vehicle travels at a high speed and/or for a long period of time, and the brakes might not function as expected and slow down the vehicle within a desirable time and distance. Having an accurate understanding of the capability of the brakes without an explicit sensor can allow for a reduction in cost and design complexity. Further, preemptively controlling speed based on estimation or prediction of brake capability can allow for improved safety of the user by informing and acting to limit potential hazardous situations in relation to faded braking performance or loss of function.

### SUMMARY

The disclosure relates generally to a process of controlling speed of a vehicle. More specifically, various embodiments of this disclosure relate to a process of controlling speed of a vehicle based on brake temperature estimation.

An aspect is directed to a method for controlling a speed of a vehicle based on braking capability, the method includes estimating a current temperature of a brake of the vehicle. The brake can have a maximum operating temperature. The method further includes determining a thermal margin for the brake and determining a speed limit for the vehicle. The speed limit can be based at least in part on the thermal margin. The method can also include applying the speed limit to the vehicle.

A variation of the aspect above is, wherein determining the speed limit comprising determining road conditions for the vehicle.

A variation of the aspect above is, wherein the brake is the hottest brake of the vehicle at the time of the temperature estimation.

A variation of the aspect above is, wherein the thermal margin comprises an amount of heat energy that if absorbed by the brake would increase a temperature of the brake from the current temperature to the maximum operating temperature.

A variation of the aspect above further includes determining a torque limit for a motor of the vehicle. The torque limit can be based at least in part on the speed limit. The method further includes applying the torque limit to the vehicle.

A variation of the aspect above is, wherein determining the speed limit for the vehicle comprises estimating a current temperature, determining a thermal margin, and determining a speed limit based at least in part on the thermal margin for each brake of the vehicle; and picking a lowest speed limit to be the speed limit for the vehicle.

A variation of the aspect above is, wherein the current temperature of the brake of the vehicle is estimated based at least in part on pressure data of the brake and/or current speed of the vehicle.

Another aspect is directed to a system for controlling a speed of a vehicle based on braking capability. The system includes a processor configured to estimate a current temperature of the brake of the vehicle, the brake having a maximum operating temperature. The processer can be configured to also determine a thermal margin for the brake, and determine a speed limit for the vehicle. The speed limit can be based at least in part on the thermal margin. The processer can be configured to also apply the speed limit to the vehicle.

A variation of the aspect above is, wherein the thermal margin comprises an amount of heat energy that if absorbed by the brake would increase a temperature of the brake from the current temperature to the maximum operating temperature.

A variation of the aspect above is, wherein the processor is configured to determine a torque limit for a motor of the vehicle. The torque limit is based at least in part on the speed limit. The processor is also configured to also apply the torque limit to the vehicle.

A variation of the aspect above further is, wherein calculating the torque limit comprising determining road conditions for the vehicle.

A variation of the aspect above is, wherein the brake is the hottest brake of the vehicle at the time of the temperature estimation.

A variation of the aspect above is, wherein the processor is further configured to estimate a current temperature, determining a thermal margin, and determining a speed limit based at least in part on the thermal margin for each brake of the vehicle; and pick a lowest speed limit to be the speed limit for the vehicle.

A variation of the aspect above is, wherein the current temperature of the brake of the vehicle is estimated based at least in part on pressure data of the brake and/or current speed of the vehicle.

Another aspect is directed to a method for controlling a speed of a vehicle based on braking capability, the method includes estimating a current temperature of a brake of the vehicle. The brake can have a maximum operating temperature. The method further includes determining a thermal margin for the brake and determining a torque limit for the vehicle. The torque limit can be based at least in part on the thermal margin. The method can also include applying the torque limit to the motor.

A variation of the aspect above is, wherein determining the torque limit comprises determining road conditions for the vehicle.

A variation of the aspect above is, wherein the brake is the hottest brake of the vehicle at the time of the temperature estimation.

A variation of the aspect above is, wherein the thermal margin comprises an amount of heat energy that if absorbed by the brake would increase a temperature of the brake from the current temperature to the maximum operating temperature.

A variation of the aspect above is, wherein determining the speed limit for the vehicle comprises estimating a current temperature, determining a thermal margin, and determining a speed limit based at least in part on the thermal margin for each brake of the vehicle; and picking a lowest speed limit to be the speed limit for the vehicle.

A variation of the aspect above is, wherein the current temperature of the brake of the vehicle is estimated based at least in part on pressure data of the brake and/or current speed of the vehicle.

### BRIEF DESCRIPTION OF THE DRAWINGS

The present disclosure is described with reference to the accompanying drawings, in which like reference characters reference like elements, and wherein:

FIG. 1 is an exemplary chart showing a mapping of torque limits as a function of the speed limit and brake temperature.

FIG. 2 is the exemplary chart from FIG. 1, adding a torque versus speed line at a temperature of 25° C. and a torque versus speed line at a temperature of 500° C.

FIG. 3 is the exemplary chart from FIG. 2 with an envelope formed between the three lines.

FIG. 4 shows exemplary simulation results recording time versus temperature conducted with different temperature limits and different test profiles.

FIG. 5 shows exemplary simulation results recording time versus velocity conducted with different temperature limits and different test profiles.

FIG. 6 shows exemplary simulation results recording time versus torque conducted with different temperature limits and different test profiles.

FIG. 7 shows a block diagram illustrating an exemplary speed-controlling system according to this disclosure.

FIG. 8 shows a flow diagram illustrating an exemplary speed-controlling process according to this disclosure.

### DETAILED DESCRIPTION

Generally described, one or more aspects of the present disclosure relate to a process of controlling speed of a vehicle. In certain embodiments, this disclosure relates to a process of controlling the speed of a vehicle based on brake temperature estimation. The process of controlling speed can include using a thermal model to estimate brake temperatures. The brake thermal model can be different for different vehicles having different weights, structures, and speeding/braking mechanisms. In some embodiments, the brake thermal model can provide an estimation of brake temperatures without a temperature sensor. The brake thermal model can provide information regarding a thermal margin or heat capability remaining in the braking system of a vehicle. For example, the thermal margin, or the amount of heat energy needed to bring each brake above its maximum temperature (e.g., a temperature at which the brake may fade or break down), can be calculated using a brake temperature estimation from the brake thermal model.

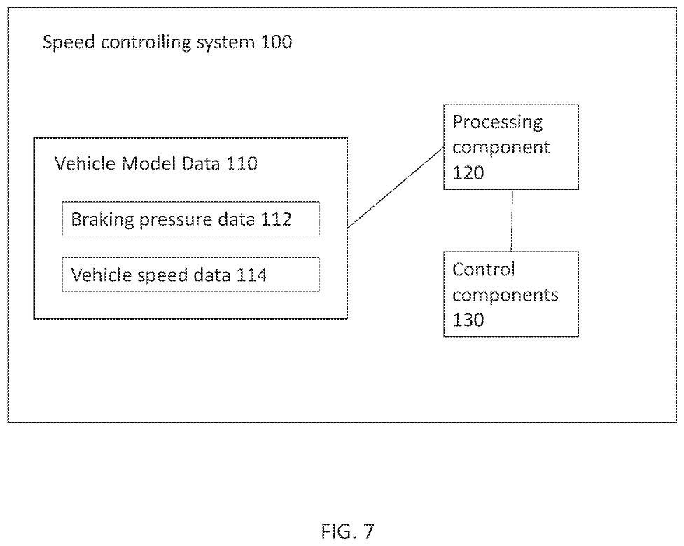

The speed-controlling process can further include using a vehicle model to determine a maximum speed a vehicle can reach when the brakes are at certain temperatures. Within or at the maximum speed limit, the vehicle brakes can be actuated to safely slow down the vehicle without fading or losing the capability to create friction (e.g., without reaching or exceeding the maximum temperature at which the brake may fade or break down). In some embodiments, as illustrated in FIG. 7, the vehicle model can employ a speed-controlling system 100 using vehicle model data 110. In some embodiments, the vehicle model data 110 can include braking pressure data 112 and vehicle speed data 114 of a vehicle. The vehicle model data 110 may be used by a processing component 120 to calculate and convert the heat capability to a maximum vehicle speed specific to a vehicle.

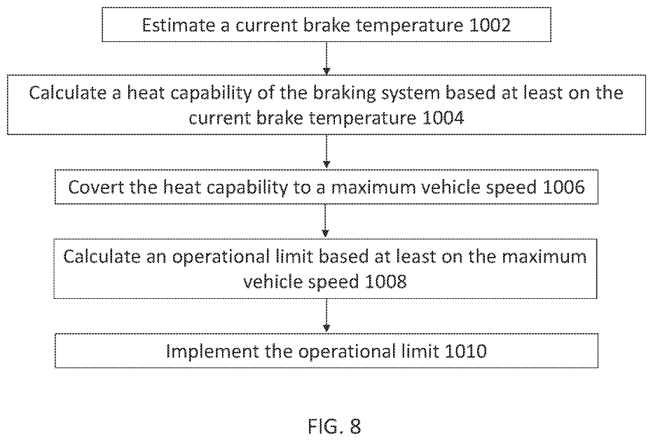

For example, during an exemplary speed-controlling process shown in FIG. 8, when a vehicle is traveling at a certain speed, the processing component 120 of the speed-controlling system 100 can use a thermal model to estimate a current brake temperature in step 1002. In step 1004, in some embodiments, the processing component 120 of the speed-controlling system 100 can calculate the heat capability of the braking system (e.g., the amount of heat energy needed to bring each brake above its max temperature) using the current estimated brake temperature and other data for the specific vehicle model (e.g., heat capacity of the brakes) from the vehicle model data 110. Then in step 1006, in some embodiments, the speed-controlling system 100 can then convert the heat capability to a maximum vehicle speed using vehicle model data 110 data from the vehicle model (e.g., mass of the vehicle).

In some embodiments, in step 1008, the processing component 120 of the speed-controlling system 100 can further calculate an operational limit (e.g., torque limit of a vehicle engine or electric motor) that can limit the vehicle to the determined speed limit. In some embodiments, for example, as long as the motor is controlled to apply a torque that does not exceed the torque limit, the vehicle can be limited to travel at or below the speed limit. In some embodiments, the speed-controlling system 100 may further include control components 130 that can be configured to receive and implement the operational limit to control the speed of the vehicle, e.g., by controlling the vehicle engine or electric motor, in step 1010. The calculation of the operational limit can also depend on many variables, such as the condition or inclination of the road the vehicle is traveling on. In some embodiments, the speed-controlling process can also include using information of road grade to determine the torque limit. For example, when a vehicle is traveling on a flat road, a lower torque limit may be set to limit the vehicle at a certain speed limit.

In some embodiments, the speed-controlling system 100 can also be implemented on a vehicle with a regenerative braking system by using a set of vehicle data and calculations specific to the regenerative braking system.

A vehicle can include brakes on each drive axle (e.g., front brakes and rear brakes). In some embodiments, the speed-controlling process can base calculations on temperature estimates of all brakes of a vehicle and then apply the lowest speed limit to make sure none of the brakes fades or loses function. In some embodiments, the speed-controlling process can base calculations on the highest estimated temperature for all of the brakes. In some embodiments, the highest estimated temperature is for a brake on the front axle. In some embodiments, the highest estimated temperature is for a brake on the rear axle. In some embodiments, the speed-controlling process can base calculations on the estimated temperature of only brakes on the front axle. In other embodiments, the speed-controlling process can base calculations on an estimation or prediction of other capabilities of the one or more brakes of a vehicle.

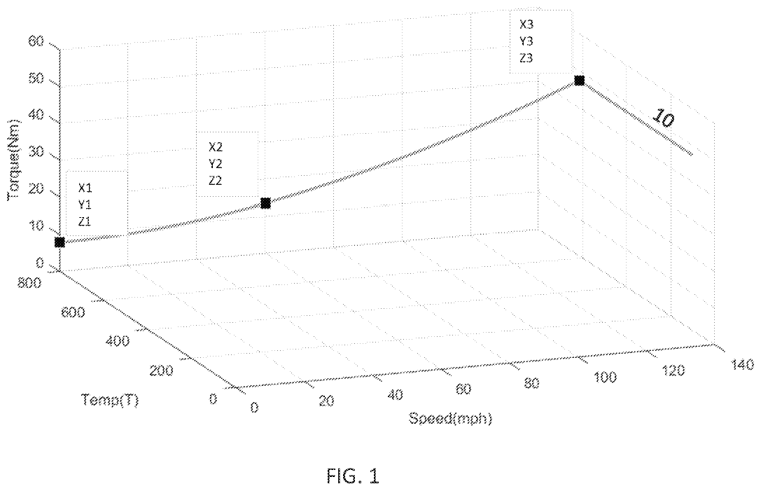

FIGS. 1-3 are exemplary charts mapping torque limits as a function of speed limit and brake temperature with X being speed, Y being temperature, and Z being torque limits. Line 10 in FIG. 1 illustrates how torque limit can correspond to the speed limit and brake temperature for a particular vehicle model under certain conditions using a speed-controlling process according to this disclosure. For example, when a brake of a vehicle is estimated to be at a temperature of Y2° C., the vehicle can be limited to be at or under X2 mph. At Z2 mph or below, the remaining capability or capacity of the brake system is sufficient to safely stop the vehicle. To maintain a speed of Z2 mph, the vehicle can limit the torque output of the motor to Z2 Nm. That is, according to FIG. 1, applying the speed-controlling process under specific conditions, a vehicle can be configured to operate under a Z2 Nm torque limit to travel at or under X2 mph when a brake temperature of Y2° C. is estimated. The flat portion of line 10 with a constant Z value (e.g., at Z3 Nm) corresponds to the torque value needed to maintain the corresponding speed limit of the vehicle. In certain embodiments, the flat portion corresponds to a range of temperature and speeds where no torque limiting is actually applied according to the speed-controlling process. FIG. 1 illustrates that in some embodiments, a speed-controlling process can use a function represented by line 10 to determine speed and/or torque limits based on brake temperatures.

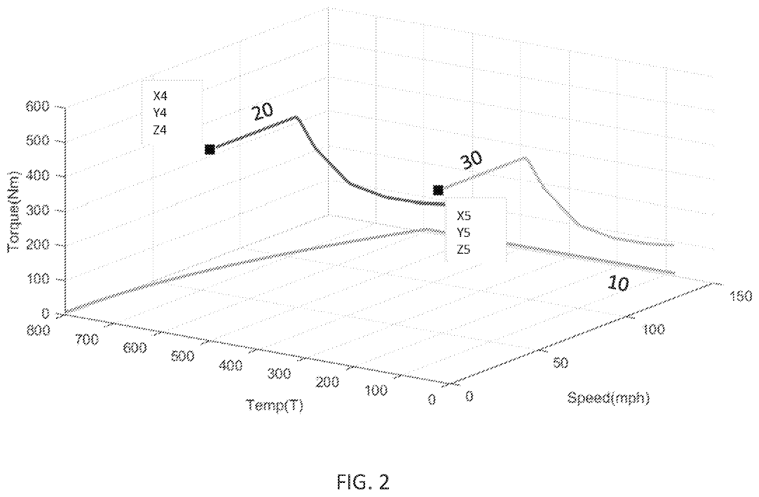

FIG. 2 is the chart from FIG. 1, adding an exemplary system level torque versus speed line 20 at a brake temperature of Y4° C. (e.g., 500° C. ) and an exemplary torque versus speed line 30 at a temperature of Y5° C. (e.g., 25° C. ) to form bounds of an envelope of torque output limit. The flat portions of lines 20 and 30 with a constant Z value (e.g., Z4 Nm for line 20 and Z5 Nm for line 30) correspond to the torque values needed to maintain the corresponding speed limits of the vehicle. In certain embodiments, the flat portions correspond to a range of temperatures and speeds where no torque limiting is actually applied according to the speed-controlling process. In some embodiments, line 20 is added at a brake temperature of 500° C. because at a brake temperature of 500° C., the remaining capability or capacity of the brake system is sufficient to safely stop the vehicle from the vehicle's maximum speed. In some embodiments, line 20 and line 30 can be added at a temperature of 600° C. and 0° C. In other embodiments, line 20 and line 30 can be added at any other desirable temperatures based on various considerations and factors (e.g., different brake materials, vehicle conditions, and road conditions).

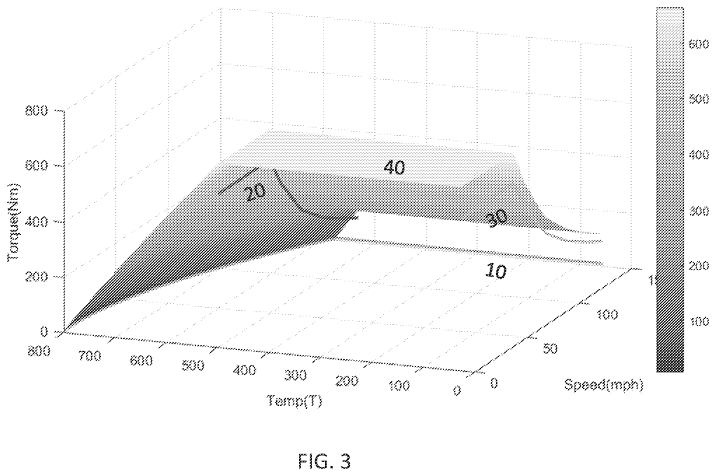

FIG. 3 is the chart from FIG. 2 with an envelope 40 formed by continuously blending the lines 20 and 30 to line 10. Envelope 40 can define a torque limit for each speed and brake temperature coordinate. FIG. 3 illustrates that in some embodiments, a speed-controlling process can use a function represented by lines 10, 20, 30, and envelope 40 to determine the speed and/or torque limits based on brake temperatures.

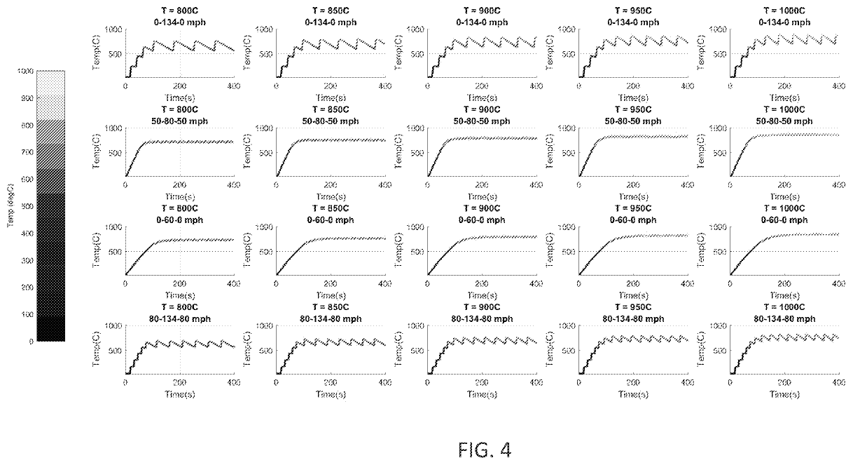

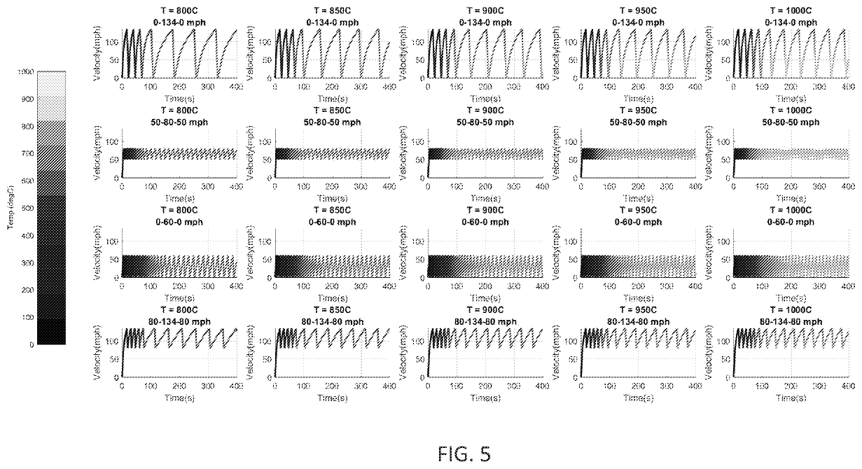

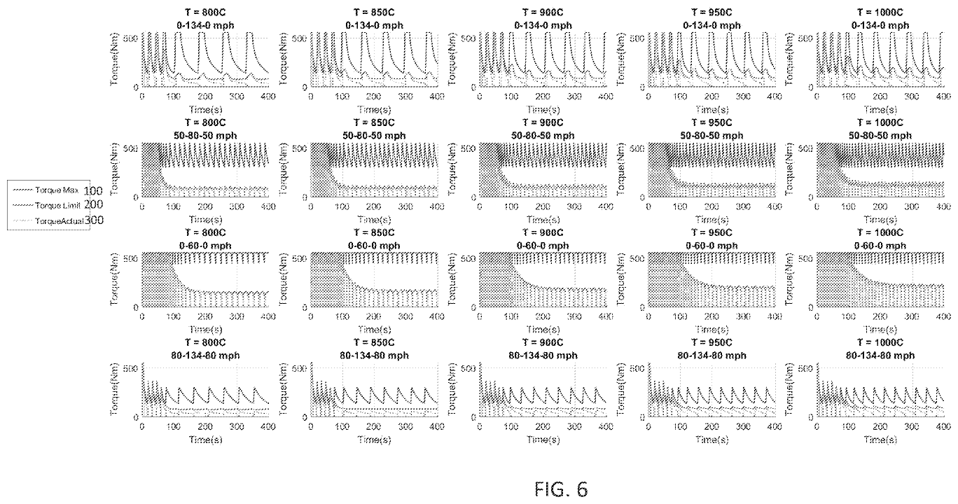

FIGS. 4-6 are exemplary simulation results conducted with different temperature limits and different test profiles. FIG. 4 shows simulated results recording time versus temperature. FIG. 5 shows simulated results recording time versus velocity. FIG. 6 shows simulated results recording time versus torque. As shown in FIGS. 4-6, a speed-controlling process can be tested and fine-tuned with different temperature limits (e.g., maximum brake temperatures considered allowable) and different test profiles (e.g., adjusting speed to go from 0 mph to 134 mph and back to 0 mph as shown in first rows in each of FIGS. 4-6).

As shown in FIG. 4, each chart shows a line with temperature, or y value, not exceeding the preset temperature limits (e.g., 800° C. , 850° C., etc.). These results can be an indication that the speed-controlling process implemented is effective in controlling brake temperatures to be under the preset allowable temperature limit of the brakes.

As shown in FIG. 5, each chart shows a line with velocity, or y value, corresponding to the speed prescribed by the test profiles (e.g., 0-134-0 mph, 50-80-50 mph, etc.). These results can be an indication that the speed-controlling process implemented is effective in controlling speed limits to be under the determined speed limits of the vehicle.

As shown in FIG. 6, each chart shows a torque max line 100 recording allowable maximum torques under current brake temperatures and speeds, a torque limit line 200 recording torque limits determined by the speed-controlling process under the brake temperatures and speeds, and a torque actual line 300 recording the actual torque applied. These results showing torque actual line 300 under the torque limit line 200 under the torque max line 100 can be an indication that the speed-controlling process implemented is effective in controlling speed under different temperature limits and test profiles with implementing the torque limits determined by the speed-controlling process.

In certain embodiments, the speed-controlling process can include determining and informing a preferred front-to-rear brake bias for improved thermal performance. Front and rear brakes of a vehicle often work under different pressures due to their different roles, configurations, and placement in the vehicle. An overall braking efficiency can be maximized by adjusting a proportion of braking forces between the front and rear brakes (e.g., brake bias). A preferred front-to-rear brake bias can be informed by the speed-controlling process, for example, by determining the maximum allowable temperatures of the front and rear brakes, the torque to be applied to the front and rear brakes, and related information.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed process of controlling speed. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as controlling of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first,” “second,” “third,” “primary,” “secondary,” “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A method for controlling a speed of a vehicle based on braking capability, comprising:
estimating a current temperature of a brake of the vehicle, the brake having a maximum operating temperature;
determining a thermal margin for the brake,
determining a speed limit for the vehicle, the speed limit being based at least in part on the thermal margin; and
applying the speed limit to control the speed of the vehicle.

2. The method of claim 1, wherein determining the speed limit comprises determining road conditions for the vehicle.

3. The method of claim 1, wherein the brake is the hottest brake of the vehicle at the time of the temperature estimation.

4. The method of claim 1, wherein the thermal margin comprises an amount of heat energy that if absorbed by the brake would increase a temperature of the brake from the current temperature to the maximum operating temperature.

5. The method of claim 1, further comprising:
determining a torque limit for a motor of the vehicle, the torque limit being based at least in part on the speed limit; and
applying the torque limit to the vehicle.

6. The method of claim 1, wherein determining the speed limit for the vehicle comprises estimating a current temperature, determining a thermal margin, and determining a speed limit based at least in part on the thermal margin for each brake of the vehicle; and picking a lowest speed limit to be the speed limit for the vehicle.

7. The method of claim 1, wherein the current temperature of the brake of the vehicle is estimated based at least in part on pressure data of the brake and/or current speed of the vehicle.

8. A system for controlling a speed of a vehicle based on braking capability, comprising:
a processor configured to:
estimate a current temperature of the brake of the vehicle, the brake having a maximum operating temperature;
determine a thermal margin for the brake;
determine a speed limit for the vehicle, the speed limit being based at least in part on the thermal margin; and
apply the speed limit to control the speed of the vehicle.

9. The speed-controlling system of claim 6, wherein the thermal margin comprises an amount of heat energy that if absorbed by the brake would increase a temperature of the brake from the current temperature to the maximum operating temperature.

10. The speed-controlling system of claim 6, wherein the processor is configured to:
determine a torque limit for a motor of the vehicle, the torque limit being based at least in part on the speed limit; and
apply the torque limit to the vehicle.

11. The speed-controlling system of claim 6, wherein calculating the torque limit comprises determining road conditions for the vehicle,

12. The speed-controlling system of claim 6, wherein the brake is the hottest brake of the vehicle at the time of the temperature estimation.

13. The speed-controlling system of claim 8, wherein the processor is further configured to estimate a current temperature, determining a thermal margin, and determining a speed limit based at least in part on the thermal margin for each brake of the vehicle; and pick a lowest speed limit to be the speed limit for the vehicle.

14. The speed-controlling system of claim 8, wherein the current temperature of the brake of the vehicle is estimated based at least in part on pressure data of the brake and/or current speed of the vehicle.

15. A method for controlling a speed of a vehicle based on braking capability, comprising:
estimating a current temperature of a brake of the vehicle, the brake having a maximum operating temperature;
determining a thermal margin for the brake;
determining a torque limit for a motor of the vehicle, the torque limit being based at least in part on the thermal margin; and
applying the torque limit to limit the speed of the motor.

16. The method of claim 15, wherein determining the torque limit comprises determining road conditions for the vehicle.

17. The method of claim 15, wherein the brake is the hottest brake of the vehicle at the time of the temperature estimation.

18. The method of claim 15, wherein the thermal margin comprises an amount of heat energy that if absorbed by the brake would increase a temperature of the brake from the current temperature to the maximum operating temperature.

19. The method of claim 15, wherein determining the speed limit for the vehicle comprises estimating a current temperature, determining a thermal margin, and determining a speed limit based at least in part on the thermal margin for each brake of the vehicle; and picking a lowest speed limit to be the speed limit for the vehicle.

20. The method of claim 15, wherein the current temperature of the brake of the vehicle is estimated based at least in part on pressure data of the brake and/or current speed of the vehicle.
